(19) United States
(12) Patent Application Publication
(10) Pub. No.: US 2001/0012801 A1
(43) Pub. Date: Aug. 9, 2001

(54) Recording medium, method and computer for executing a shooting game in an entertainment system

(76) Inventor: Nobuhiro Komata, Tokyo (JP)

Correspondence Address: HELFGOTT & KARAS, P.C., 60th FLOOR, EMPIRE STATE BUILDING, NEW YORK, NY, 10118-0110, US

(21) Appl. No.: 09/757,806

(22) Filed: Jan. 10, 2001

(30) Foreign Application Priority Data
Jan. 14, 2000 (JP) 2000-40270

(51) Int. Cl. A63F 13/00

(52) U.S. Cl. 463/37

(57) ABSTRACT

A method and a computer for executing a shooting game which is played by a user using a controller to enhance the nature of the game without eliminating its rapid-fire function. The computer that executes a shooting game includes a controller having a pressure sensing unit that detects an operation pressure by a player during a shooting operation, a unit that determines the number of projectiles to be shot according to the pressure in the shooting operation detected by said pressure sensing unit, a unit that shoots the determined number of projectiles to be shot by a player character on the monitor, and a unit that decides whether the enemy character has been shot.

### FIELD OF THE INVENTION

This invention relates to a recording medium, a method using a pressure-sensitive controller, and a computer for executing a shooting game.

### BACKGROUND OF THE INVENTION

Among computer games, a “shooting game” is one in which the player, via a controller, shoots projectiles from objects in a game space to hit enemies, etc., and competes with another player or a computer to gain points based on his hit rate, the damage he inflicts on the enemies, etc.

Generally in such a game, an arbitrary button on the controller of the computer is assigned as a trigger switch, and every time it is pressed by a user, a projectile is shot.

In order to play the game dominantly, it is necessary to twitch one's finger in a quick vibration to shoot off many projectiles per unit time, turning the switch on and off many times during a short period of time. Because of differences from one individual to another, recently controllers have become available that have a switch dedicated to a rapid-fire operation, or software used may cause a predetermined switch on the controller to function as a rapid-fire switch.

Such switches make it simple to shoot rapidly, even for someone who does not have the skill to execute a rapid-fire barrage by twitching his finger in rapid succession.

As prior art for shooting games, one can refer to Japanese unexamined patent Laid-open Nos. H11-047438 [1999], H11-047448 [1999], H11-052898 [1999], H11-053082 [1999], and H11-053571 [1999]. As prior art for rapid-fire buttons, one can refer to Japanese unexamined patent Laid-open No. H11-076615 [1999].

Meanwhile, for computer input devices, mainly for the input devices of entertainment systems typified by game devices, there is a so-called pressure-sensitive controller. The pressure-sensitive controller outputs as a pressure sensing value a pressing force that results when a player applies pressure with his or her finger to an operation element itself that is connected to a pressure-sensitive element. As a specific example, a pressure-sensitive controller is disclosed in, for example, Japanese utility model Publication H1-40545 [1989], but here the pressure sensing output is input to a variable control oscillator (VCO), and the output of the VCO is used for rapid firing in the game.

However, in shooting games as described above, putting or allocating a rapid-fire button on the controller brings everyone to the same level, which presents the problem that rapid firing that reflects the skill of the player cannot be realized, ultimately detracting from the character of the game.

### SUMMARY OF THE INVENTION

It is an object of the present invention to provide a recording medium, a method using the controller and a computer for executing a shooting game, which enhance the character of the game, without eliminating the rapid-fire function.

This and other objects of the invention are obtained by a recording medium on which are recorded shooting game software programs, including programs that process as commands an output from a controller that has a pressure sensing means, that can be read and executed by a computer, and the software programs include processing programs that shoot projectiles in the screen of the computer in a number that corresponds to the output of the controller.

A method of executing a shooting game of the present invention, using a pressure-sensitive controller in shooting games comprises detecting the pressure of the shooting operation by a pressure sensing means provided on the controller, determining the number of projectiles to be shot in accordance with the pressure of the shooting operation detected by the pressure sensing means, shooting the determined number of projectiles to be shot by the user character on the monitor, and deciding whether the enemy character has been hit.

The computer of this invention executes a shooting game and comprises a controller having a pressure sensing means that detects an operation pressure, a means that determines the number of projectiles to be shot in accordance with the pressure of the shooting operation detected by the pressure sensing means, a means that shoots the determined number of projectiles to be shot by the user character on the monitor, and a means that decides whether the enemy character has been shot.

### BRIEF DESCRIPTION OF THE DRAWINGS

FIG. 1 is a diagram showing a connection of the controller to the entertainment system to enable a player to enjoy game software or images using the entertainment system;

FIG. 2 is a diagram showing a scene in which, in a shooting game, projectiles G are fired at enemy characters according to operation by the player, and a projectile strikes;

FIG. 3 is a table for selecting the number of projectiles to be shot per unit time according to a respective pressure sensing value;

FIG. 4 is a flowchart of processing a shooting game, including a program for projectile shooting;

FIG. 5 is a perspective view of the controller connected to the entertainment system;

FIG. 6 is a block diagram of the entertainment system;

FIG. 7 is a top plan view showing the appearance of the controller;

FIG. 8 is an exploded perspective view of the second control part of the controller;

FIGS. 9A-9C are cross-sectional views of the second control part of FIG. 8;

FIG. 10 is a diagram showing the equivalent circuit of the pressure sensing circuit element;

FIG. 11 is a block diagram of the main parts of the controller;

FIG. 12 is an exploded perspective view of the first control part of the controller;

FIG. 13 is a cross-sectional view of the first control part of FIG. 12;

FIG. 14 is a diagram showing the circuit of the resistor;

FIG. 15 is a graph the characteristics of the output signal of the controller;

FIG. 16 is a block diagram showing the overall composition, including the resistor; and

FIG. 17 is an exploded perspective view of the third control part of the controller.

### DETAILED DESCRIPTION OF THE PREFERRED EMBODIMENT

With a controller that uses pressure-sensitive elements, when a button, which is an operation element, is pressed by a player, the controller not only detects the presence or absence of its pressure sensing output, for example, whether the switch is on or off, but also obtains a pressure sensing value outputted in accordance with the pushing pressure of the player. Meanwhile, in the software or game that makes use of pressure sensing value output, processing or action can be decided upon in correspondence with the pressure sensing value output. This embodiment has been made in such a way that even if, for example, projectiles are shot on the screen according to operation of the operation elements, the speed of the shooting varies according to the pressure sensing value due to the pushing operation on each operation element.

That is, in this embodiment, in software for firing projectiles according to operations as in a so-called shooting game, projectiles are shot as images on the screen at a speed corresponding to the pressure sensing value output when a controller is operated that has a pressure sensing element by a user. This provides a user interface than is even better than one in which the on operation of a simple on-off switch is repeated or continued.

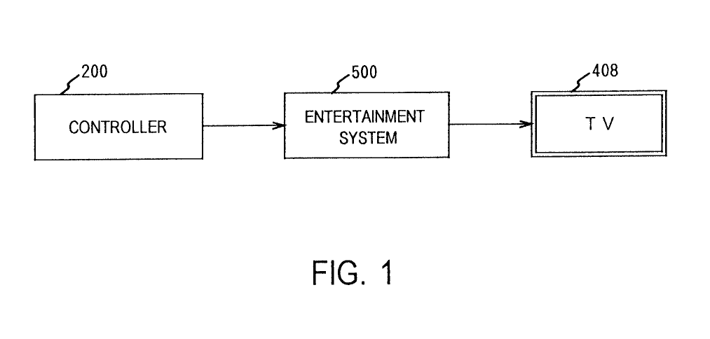

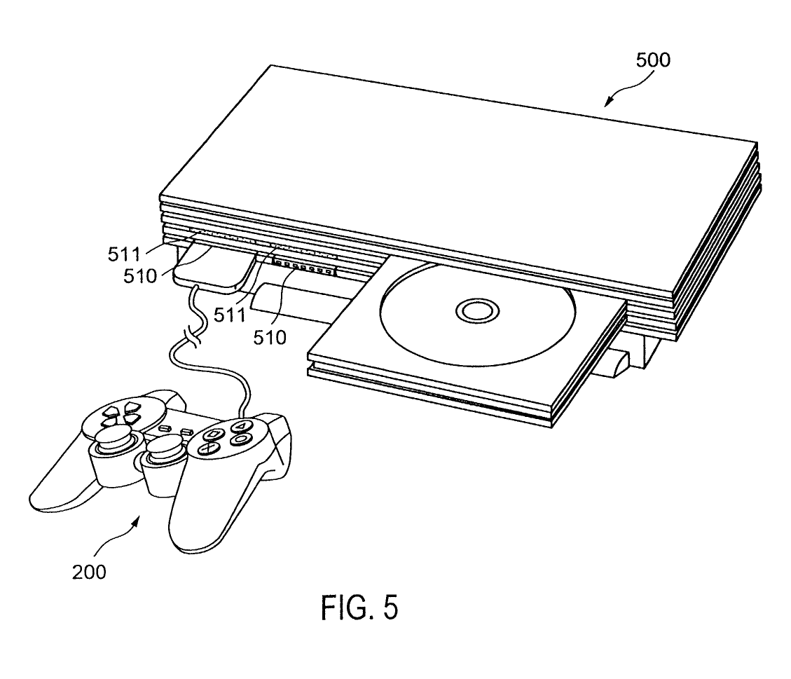

FIG. 1 is a diagram for showing a connection of a controller to an entertainment system 500 to enable a user to enjoy game software or images using entertainment system 500. A more specific structure is shown in FIG. 5.

As shown in FIG. 1, a controller 200, which has buttons connected to pressure sensing elements provided inside the controller is, for example connected to entertainment system 500 for playing games or enjoying the images on a DVD video, etc., and the image output terminal of the entertainment system 500 is connected to television monitor 408. Here, the analog output from the pressure sensing elements is converted to digital values from 0 to 255 by an analog-to-digital converter and is supplied to entertainment system 500.

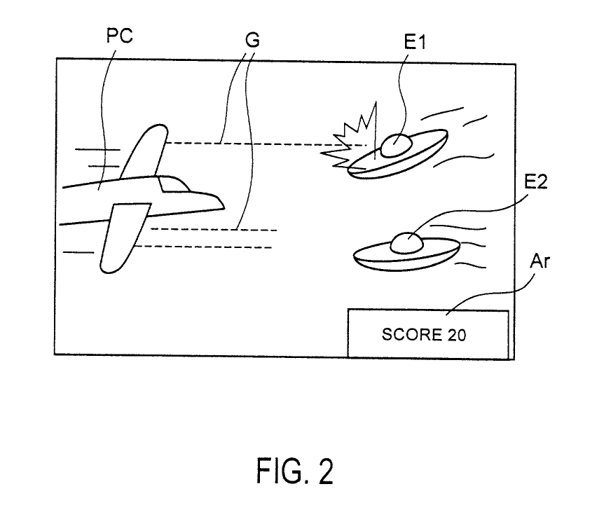

With reference to FIGS. 2-4, the case in which projectiles are fired on the screen by operation of controller 200 will be now described.

FIG. 2 shows a scene in which, in a shooting game, projectiles G are fired at enemy characters E1, E2 according to operation by the player from a player character PC operated by the player, and a projectile G strikes enemy character E1.

In such a shooting game, every time a projectile hits enemy characters E1, E2, the prescribed number of points are awarded and are added to the player's score. Area “Ar” in the lower right corner of the screen is the score area; in this example, it is shown that the player's score at the present time is 20 points.

In shooting games heretofore, in order to fire projectiles in rapid succession it has been necessary to repeatedly hit a button by hand or to have a rapid-fire button that makes use of a variable control oscillator. In order to fire in succession, one must repeatedly press a button. And if one uses a controller that has a switch just for firing in rapid succession, then no matter how a player manipulates the controls, the number of projectiles shot off per unit time remains constant, thereby not reflecting the degree of learning and skill the player has acquired and greatly detracting from the experience as a competitive game.

In this embodiment the shooting of projectiles is automatically done at a speed that depends on the pressure sensing value from the pressure-sensitive controller.

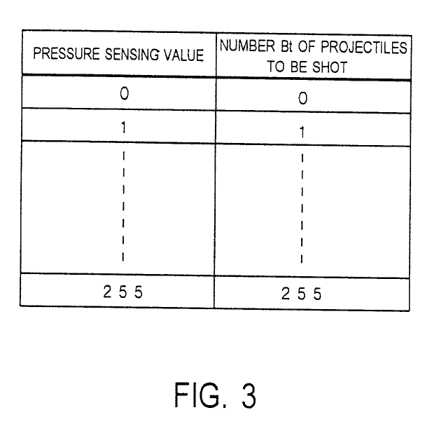

Shown in FIG. 3 is a table for selecting the number Bt of projectiles to be shot per unit time according to each pressure sensing value from 0 to 255. Of course, this table is only an example; one can use any table in which the number Bt of projectiles is set in association with the pressure sensing value of the controller.

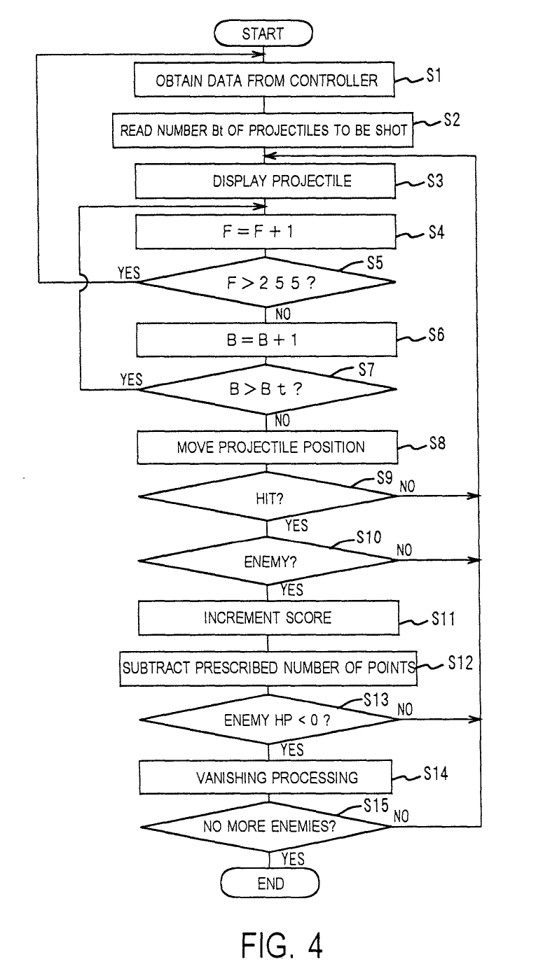

Next, referring to FIG. 4, the method by which projectiles are fired off at a speed that depends on the pressure sensing value will be explained. The flowchart in FIG. 4 shows the shooting game processing, including the program for shooting projectiles.

In FIG. 4, in step S1, the pressure sensing value from controller 200 is obtained, and in step S2, reference is made to the table shown in FIG. 3 to read the number Bt of projectiles to be shot that corresponds to the acquired pressure sensing value.

In step S3, the projectiles are displayed. That is, an image of projectile G as shown in FIG. 2 is written into the video memory that corresponds to the front of player character PC. An image of one frame into which the image of projectile G is newly written is displayed on television monitor 408.

In step S4, the number F of frames is incremented by 1, and in step S5, it is decided whether the number F of frames is greater than 255; if “YES”, the processing returns to step S1, and if “NO”, the processing proceeds to step S6.

The reason why the maximum value of the number of frames is taken to be 255 is that, as shown in FIG. 3, one cycle for acquiring the pressure sensing value and shooting projectiles in accordance with that value is set to 255 frames. This is because the maximum number of shots per unit time is set to 255. This is because, in this case, if one cycle should be made shorter than 255 frames, then two or more projectiles would have to be fired per frame. In order to avoid making the processing complicated, it is desirable to have no more than one shot per frame.

In step S6, the number B of projectiles is incremented by 1, and in step S7, it is decided whether the number B of projectiles is greater than the number Bt of projectiles to be shot that is read from the table. In the “YES” case, when the number B of projectiles is greater than the number Bt of projectiles to be shot, the processing returns to step S4, and if on the other hand the answer is “NO”, the processing proceeds to step S8.

Having these steps S6, S7 prevents projectiles G from being shot off in a number greater than the number Bt of projectiles to be shot that is read from the table based on the pressure sensing value.

In step S8, the position information for all the projectiles G that have been written into the video memory is incremented, that is, their addresses are incremented by the prescribed amount. This prescribed amount is preset, for example, M addresses in N frames.

In step S9, it is decided whether projectile G has hit anything; if “YES”, the processing proceeds to step S10, and if “NO”, it returns to step S3.

In step S10, it is decided whether what has been hit is an enemy; if “YES”, the processing proceeds to step S11, and if “NO”, it returns to step S3.

In step S11, since the projectile has struck an enemy, the score is incremented. The updated score is displayed, for example, in area Ar for displaying the score, as shown with reference to FIG. 2.

In step S12, the prescribed number of points are subtracted from the HP, that is, the life value, of the enemy struck by projectile G.

In step S13, it is decided whether the life value HP value of the enemy that has been decremented by the prescribed number of points in step S12 is less than 0; if “YES”, processing proceeds to step S14, and if “NO”, it returns to step S3.

In step S14, a flag is set so as not to display, when drawn the next time, the enemy whose life value HP value has vanished.

In step S15, it is decided whether there are any enemies who have not been eliminated; if “YES”, the processing returns to step S3, and if “NO”, the program ends.

As described above, in this embodiment, projectiles are shot at a speed that depends on the pressure sensing value, so the number of projectiles shot can be regulated by increasing or decreasing the operation pressure. That is, if a player presses the buttons connected to the controller's pressure sensing means with full force, the number of projectiles shot per unit time and the probability of making a direct hit on an enemy is also decreased, but, on the other hand, one player's character on the screen rapidly uses up one's ammunition and runs out of it.

Conversely, if a player presses the buttons connected to the controller's pressure sensing means lightly, the number of projectiles shot per unit time are decreased and the probability of making a direct hit on an enemy is also decreased, but, on the other hand, the player's character on the screen retains its ammunition for a long time.

In this way, the outcome of the game is controlled by the degree of subtle pushing pressure by the player or user on the buttons connected to the controller's pressure sensing means. That is, the elements of how well a user has learned the game and how skillfully the user plays it are reflected in the outcome of the game, whose nature as a game can be enhanced.

This invention makes it possible to improve the user interface, making it easier to use than the conventional rapid firing by a simple on-off switch, and more game-like than using a special rapid-fire switch.

A user may also determine the rate of change between the pressure sensing value last time and the pressure sensing value currently, and shoot projectiles to an extent that corresponds to this rate of change. For example, if the last-time pressure sensing value is 100 and the current pressure sensing value is 50, the rate of change is 50%, so the number Bt of projectiles can be made ½ the number of frames the previous time.

Also, in the reverse of the table shown in FIG. 3, one may have a table in which large numbers Bt of projectiles are associated with low pressure sensing values, so that the higher the pressure sensing value, the small the number Bt of projectiles.

FIG. 5 is a diagram showing the controller 200 connected to entertainment system 500. The controller 200 is removably connected to the entertainment system 500, and the entertainment system 500 is connected to television monitor 408 as described above.

The entertainment system 500 reads the program for a computer game from recording media upon which that program is recorded and by executing the program displays characters on the television monitor 408. The entertainment system 500 has also various built-in functions for DVD (Digital Versatile Disc) playback, CDDA (compact disc digital audio) playback and the like. The signals from the controller 200 are also processed as one of the aforementioned control functions within the entertainment system 500, and the content thereof may be reflected in the movement of characters and the like, on the television monitor 408.

While this depends also on the content of the computer game program, controller 200 may be allocated functions for moving the characters displayed on the television monitor 408 in the directions up, down, left or right.

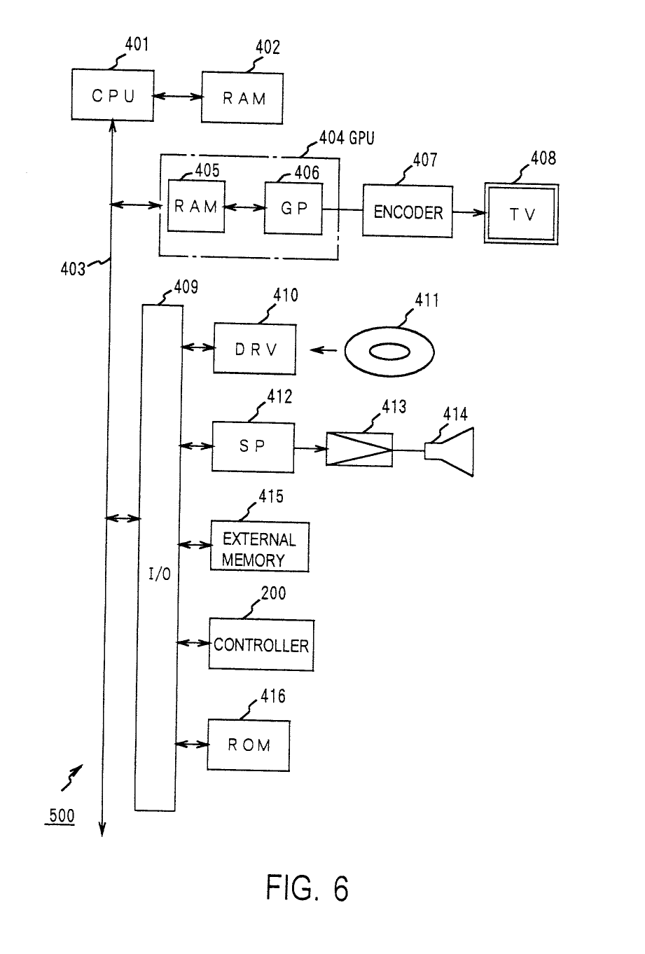

With reference to FIG. 6, here follows a description of the interior of the entertainment system 500 shown in FIG. 5. FIG. 6 is a block diagram of the entertainment system 500.

A CPU 401 is connected to RAM 402 and a bus 403, respectively. Connected to bus 403 are a graphics processor unit (GPU) 404 and an input/output processor (1/0) 409, respectively. The GPU 404 is connected via an encoder 407 for converting a digital RGB signal or the like into the NTSC standard television format, for example, to a television monitor (TV) 408 as a peripheral.

Connected to the I/O 409 are a driver (DRV) 410 used for the playback and decoding of data recorded upon an optical disc 411, a sound processor (SP) 412, an external memory 415 consisting of flash memory, controller 200 and a ROM 416 which records the operating system and the like. The SP 412 is connected via an amplifier 413 to a speaker 414 as a peripheral.

Here, the external memory 415 may be a card-type memory consisting of a CPU or a gate array and flash memory, which is removably connected via connector 511 to the entertainment system 500 shown in FIG. 5.

The controller 200 is configured such that, when a plurality of buttons provided thereupon are pushed, it gives instructions to the entertainment system 500. In addition, the driver 410 is provided with a decoder for decoding images encoded based upon the MPEG standard.

The description will be made now as to how the images will be displayed on the television monitor 408 based on the operation of controller 200. It is assumed that data for objects consisting of polygon vertex data, texture data and the like recorded on the optical disc 411 is read by the driver 410 and stored in the RAM 402 of the CPU 401.

When instructions from the player via controller 200 are provided as an input to the entertainment system 500, the CPU 401 calculates the three-dimensional position and orientation of objects with respect to the point of view based on these instructions. Thereby, the polygon vertex data for objects defined by X, Y, Z coordinate values are modified variously. The modified polygon vertex data is subjected to perspective conversion processing and converted into two-dimensional coordinate data.

The regions specified by two-dimensional coordinates are so-called polygons. The converted coordinate data, Z data and texture data are supplied to the GPU 404. Based on this converted coordinate data, Z data and texture data, the GPU 404 performs the drawing process by writing texture data sequentially into the RAM 405. One frame of image data upon which the drawing process is completed, is encoded by the encoder 407 and then supplied to the television monitor 408 and displayed on its screen as an image.

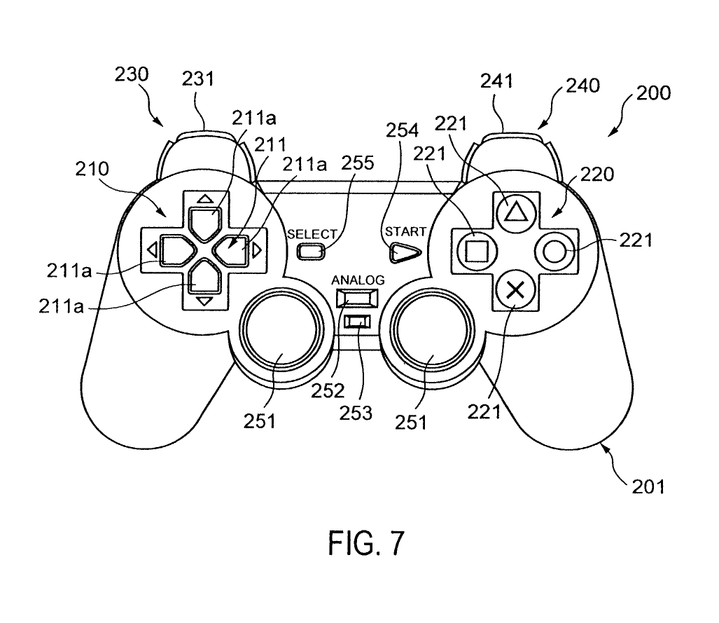

FIG. 7 is a top view of controller 200. The controller 200 consists of a unit body 201 on the top surface of which are provided first and second control parts 210 and 220, and on the side surface of which are provided third and fourth control parts 230 and 240 of the controller 200.

The first control part 210 of the controller is provided with a cruciform control unit 211 used for pushing control, and the individual control keys 211a extending in each of the four directions of the control unit 211 form a control element. The first control part 210 is the control part for providing movement to the characters displayed on the screen of the television receiver, and has the functions for moving the characters in the up, down, left and right directions by pressing the individual control keys 211a of the cruciform control unit 211.

The second control part 220 is provided with four cylindrical control buttons 221 (control elements) for pushing control. The individual control buttons 221 have identifying marks such as “◯” (circle), “X” (cross), “Δ” (triangle) and “□” (quadrangle) on their tops, in order to easily identify the individual control buttons 221. The functions of the second control part 220 are set by the game program recorded upon the optical disc 411, and the individual control buttons 221 may be allocated functions that change the state of the game characters, for example. For example, the control buttons 221 may be allocated functions for moving the left arm, right arm, left leg and right leg of the character.

The third and fourth control parts 230 and 240 of the controller have nearly the same structure, and both are provided with two control buttons 231 and 241 (control elements) for pushing control, arranged above and below. The functions of these third and fourth control parts 230 and 240 are also set by the game program recorded on the optical disc, and may be allocated functions for making the game characters do special actions, for example.

Moreover, two joy sticks 251 for performing analog operation are provided upon the unit body 201 shown in FIG. 7. The joy sticks 251 can be switched and used instead of the first and second control parts 210 and 220 described above. This switching is performed by means of an analog selection switch 252 provided upon the unit body 201. When the joy sticks 251 are selected, a display lamp 253 provided on the unit body 201 lights, indicating the state wherein the joy sticks 251 are selected.

It is to be noted that on unit body 201 there are also provided a start switch 254 for starting the game and a select switch 255 for selecting the degree of difficulty or the like at the start of a game, and the like.

The controller 200 shown in FIG. 7 is held by the left hand and the right hand of the player and is operated by the other fingers, and in particular the thumbs of the player are able to operate most of the buttons on the top surface of the controller.

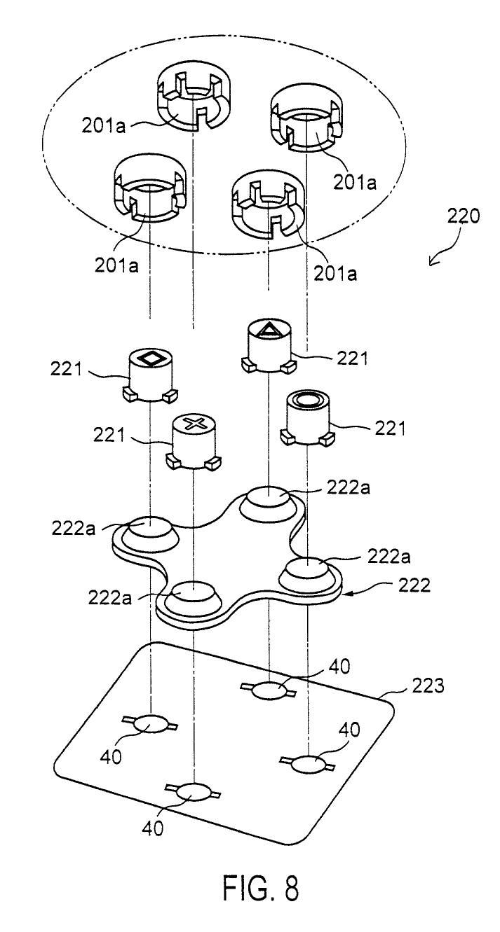

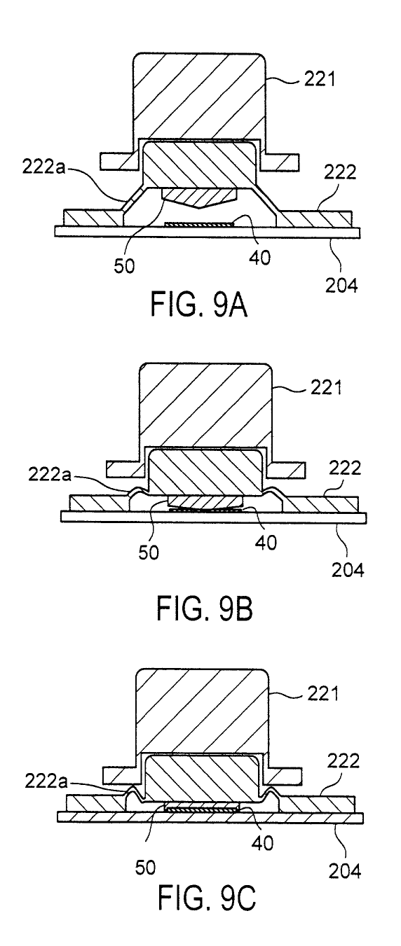

FIG. 8 and FIGS. 9A-9C are, respectively, an exploded perspective view and cross-sectional views showing the second control part of the controller.

As shown in FIG. 8, the second control part 220 includes four control buttons 221 which serve as the control elements, an elastic body 222, and a sheet member 223 provided with resistors 40. The individual control buttons 221 are inserted from behind through insertion holes 201a formed on the upper surface of the unit body 201. The control buttons 221 inserted into the insertion holes 201a are able to move freely in the axial direction.

The elastic body 222 is made of insulating rubber or the like and has elastic areas 222a which protrude upward, and the lower ends of the control buttons 221 are supported upon the upper walls of the elastic areas 222a. When the control buttons 221 are pressed, the inclined-surface portions of these elastic areas 222a flex so that the upper walls move together with the control buttons 221.

On the other hand, when the pushing pressure on the control buttons 221 is released, the flexed inclined-surface portions of elastic areas 222a elastically return to their original shape, pushing up the control buttons 221. The elastic body 222 functions as a spring means whereby control buttons 221 which had been pushed in by a pushing action are returned to their original positions. As shown in FIGS. 9A-9C, conducting members 50 are attached to the rear surface of the elastic body 222.

The sheet member 223 consists of a membrane or other thin sheet material which has flexibility and insulating properties. Resistors 40 are provided in appropriate locations on this sheet member 223 and these resistors 40 and conducting member 50 are each disposed such that they face one of the control buttons 221 via the elastic body 222.

The resistors 40 and conducting members 50 form pressure-sensitive devices. These pressure-sensitive devices consisting of resistors 40 and conducting members 50 have resistance values that vary depending on the pushing pressure received from the control buttons 221.

To describe this in more detail, as shown in FIGS. 9A-9C, the second control part 220 is provided with control buttons 221 as control elements, an elastic body 222, conducting members 50 and resistors 40. Each conducting member 50 may be made of conductive rubber which has elasticity, for example, and has a conical shape with its center as a vertex. The conducting members 50 are adhered to the inside of the top surface of the elastic areas 222a formed in the elastic body 222.

In addition, the resistors 40 may be provided on an internal board 204, for example, opposite the conducting members 50, so that the conducting members 50 come into contact with resistors 40 together with the pushing action of the control buttons 221. The conducting member 50 deforms, depending on the pushing force on the control button 221 (namely the contact pressure with the resistor 40), so as shown in FIGS. 9B and 9C, the surface area in contact with the resistor 40 varies depending on the pressure.

To wit, when the pressing force on the control button 221 is weak, as shown in FIG. 9B, only the area near the conical tip of the conducting member 50 is in contact. As the pressing force on the control button 221 becomes stronger, the tip of the conducting member 50 deforms gradually so the surface area in contact expands.

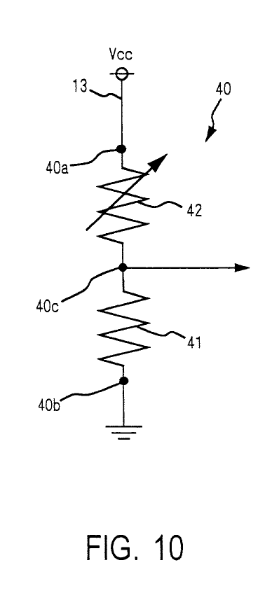

FIG. 10 is a diagram showing an equivalent circuit for a pressure-sensitive device consisting of a resistor 40 and conducting member 50. As shown in this diagram, the pressure-sensitive device is inserted in series in a power supply line 13, where the voltage V_{cc} is applied between the electrodes 40a and 40b. As shown in this diagram, the pressure-sensitive device is divided into a variable resistor 42 that has the relatively small resistance value of the conducting member 50 and a fixed resistor 41 that has the relatively large resistance value of the resistor 40. Among these, the portion of the variable resistor 42 is equivalent to the portion of resistance in the contact between the resistor 40 and the conducting member 50, so the resistance value of the pressure-sensitive device varies depending on the surface area of contact with the conducting member 50.

When the conducting member 50 comes into contact with the resistor 40, in the portion of contact, the conducting member 50 becomes a bridge instead of the resistor 40 and a current flows, so the resistance value becomes smaller in the portion of contact. Therefore, the greater the surface area of contact between the resistor 40 and conducting member 50, the lower the resistance value of the pressure-sensitive device becomes. In this manner, the entire pressure-sensitive device can be understood to be a variable resistor. It is to be noted that FIGS. 9A-9C show only the contact portion between the conducting member 50 and the resistor 40 which forms the variable resistor 42 of FIG. 10, but fixed resistor of FIG. 10 is omitted from FIGS. 9A-9C.

In the preferred embodiment, an output terminal is provided near the boundary between variable resistor 42 and fixed resistor 41, namely near the intermediate point of the resistors 40, and thus a voltage stepped down from the applied voltage V_{cc} by the amount the variable resistance is extracted as an analog signal corresponding to the pushing pressure by the user on the control button 221.

First, since a voltage is applied to the resistor 40 when the power is turned on, even if the control button 221 is not pressed by the user, a fixed analog signal (voltage) Vₘᵢₙ is provided as the output from the output terminal 40c. Next, even if the control button 221 is pressed, the resistance value of this resistor 40 does not change until the conducting member 50 contacts the resistor 40, so the output from the resistor 40 remains unchanged at Vₘᵢₙ.

If the control button 221 is pushed further and the conducting member 50 comes into contact with the resistor 40, the surface area of contact between the conducting member 50 and the resistor 40 increases in response to the pushing pressure on the control button 221, and thus the resistance of the resistor 40 is reduced so the analog signal (voltage) output from the output terminal 40c of the resistor 40 increases. Furthermore, the analog signal (voltage) output from the output terminal 40c of the resistor 40 reaches the maximum Vₘₐₓ when the conducting member 50 is most deformed.

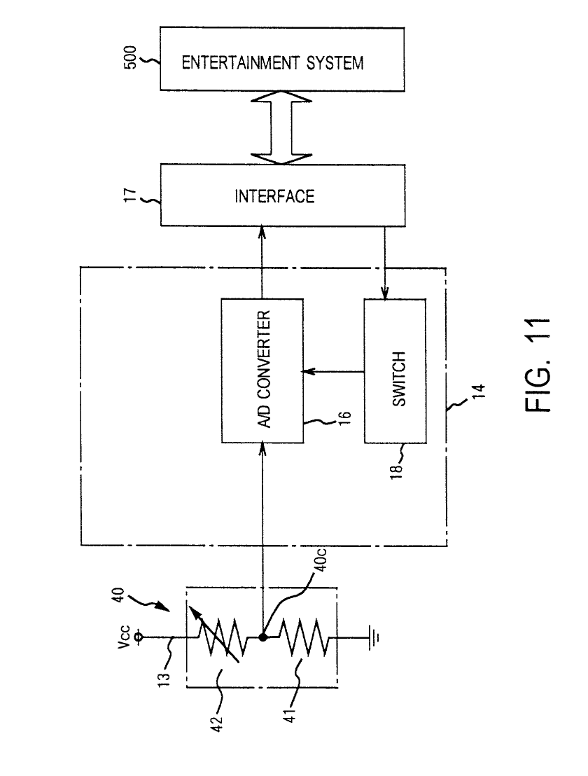

FIG. 11 is a block diagram showing the main parts of the controller 200.

An MPU 14 mounted on the internal board of the controller 200 is provided with a switch 18, an A/D converter 16. The analog signal (voltage) output from the output terminal 40c of the resistor 40 is provided as input to the A/D converter 16 and is converted to a digital signal.

The digital signal output from the A/D converter 16 is sent via an interface 17 provided upon the internal board of the controller 200 to the entertainment system 500 and the actions of game characters and the like are executed based on this digital signal.

Changes in the level of the analog signal output from the output terminal 40c of the resistor 40 correspond to changes in the pushing pressure received from the control button 221 (control element) as described above. Therefore, the digital signal outputted from the A/D converter 16 corresponds to the pushing pressure on the control button 221 (control element) from the user. If the actions of the game characters and the like are controlled based on the digital signal that has such a relationship with the pushing pressure from the user, it is possible to achieve smoother and more analog-like action than with control based on a binary digital signal based only on zeroes and ones.

The configuration is such that the switch 18 is controlled by a control signal sent from the entertainment system 500 based on a game program recorded on an optical disc 411. When a game program recorded on optical disc is executed by the entertainment system 500, depending on the content of the game program, a control signal is provided as output to specify whether the A/D converter 16 is to function as a means of providing output of a multi-valued analog signal, or as a means of providing a binary digital signal. Based on this control signal, the switch 18 is switched to select the function of the A/D converter 16.

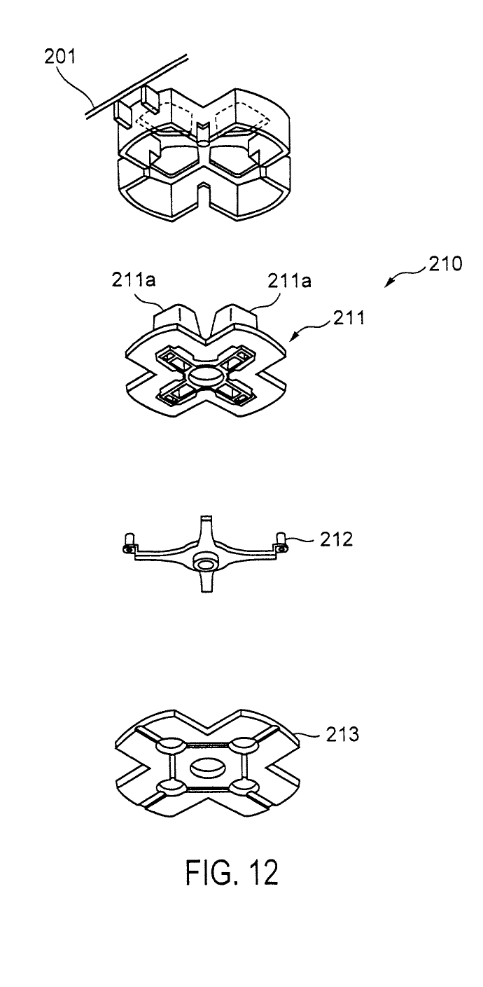

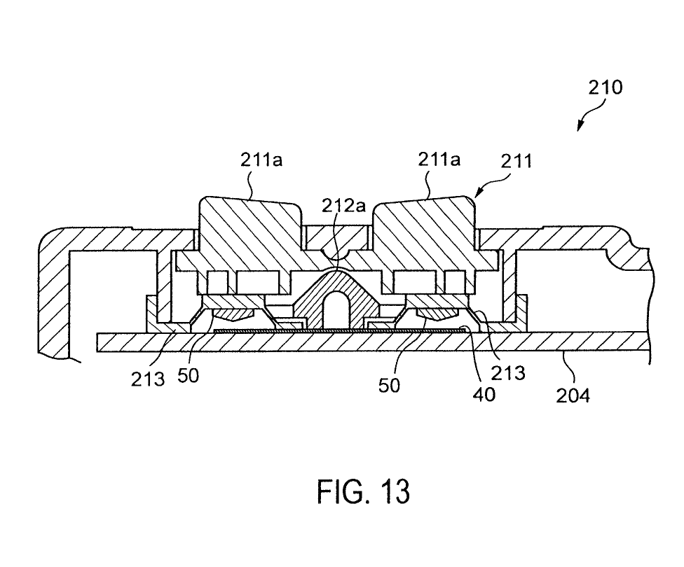

FIGS. 12 and 13 show an example of the configuration of the first control part of the controller.

As shown in FIG. 12, the first control part 210 includes a cruciform control unit 211, a spacer 212 that positions this control unit 211, and an elastic body 213 that elastically supports the control unit 211. Moreover, as shown in FIG. 12, a conducting member 50 is attached to the rear surface of the elastic body 213, and the configuration is such that resistors 40 are disposed at the positions facing the individual control keys 211a (control elements) of the control unit 211 via the elastic body 213.

The overall structure of the first control part 210 has already been made public knowledge in the publication of unexamined Japanese patent application No. JP-A-H8-163672. The control unit 211 uses a hemispherical projection 212a formed in the center of the spacer 212 as a fulcrum, and the individual control keys 211a (control elements) are assembled such that they can push on the resistor 40 side (see FIG. 13).

Conducting members 50 are adhered to the inside of the top surface of the elastic body 213 in positions corresponding to the individual control keys 211a (control elements) of the cruciform control unit 211. In addition, the resistors 40 with a single structure are disposed such that they face the individual conducting members 50.

When the individual control keys 211a which are control elements are pushed, the pushing pressure acts via the elastic body 213 on the pressure-sensitive devices consisting of a conducting member 50 and resistor 40, so that its electrical resistance value varies on the magnitude of the pushing pressure.

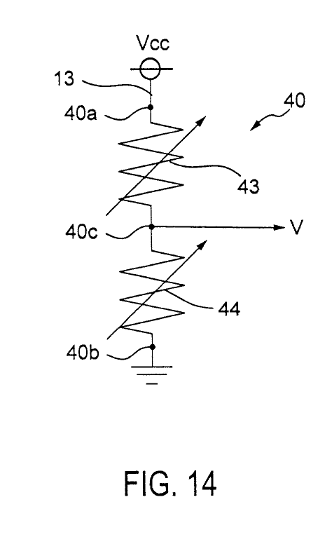

FIG. 14 is a diagram showing the circuit configuration of the resistor. As shown in this diagram, the resistor 40 is inserted in series in a power supply line 13, where a voltage is applied between the electrodes 40a and 40b. The resistance of this resistor 40 is illustrated schematically, as shown in this diagram, the resistor 40 is divided into first and second variable resistors 43 and 44.

Among these, the portion of the first variable resistor 43 is in contact, respectively, with the conducting member 50 that moves together with the control key (up-directional key) 211a for moving the character in the up direction, and with the conducting member 50 that moves together with the control key (left-directional key) 211a for moving the character in the left direction, so its resistance value varies depending on the surface area in contact with these conducting members 50.

In addition, the portion of the second variable resistor 44 is in contact, respectively, with the conducting member 50 that moves together with the control key (down-directional key) 211a for moving the character in the down direction, and with the conducting member 50 that moves together with the control key (right-directional key) 211a for moving the character in the right direction, so its resistance value varies depending on the surface area in contact with these conducting members 50.

Moreover, an output terminal 40c is provided intermediate between the variable resistors 43 and 44, and an analog signal corresponding to the pushing pressure on the individual control keys 211a (control elements) is provided as output from this output terminal 40c.

The output from the output terminal 40c can be calculated from the ratio of the split in resistance value of the first and second variable resistors 43 and 44. For example, if R1 is the resistance value of the first variable resistor 43, R2 is the resistance value of the second variable resistor 44 and V_{cc} is the power supply voltage, then the output voltage V appearing at the output terminal 40c can be expressed by the following equation.

V=V_{cc}×R2/(R1+R2)

Therefore, when the resistance value of the first variable resistor 43 decreases, the output voltage increases, but when the resistance value of the second variable resistor 44 decreases, the output voltage also decreases.

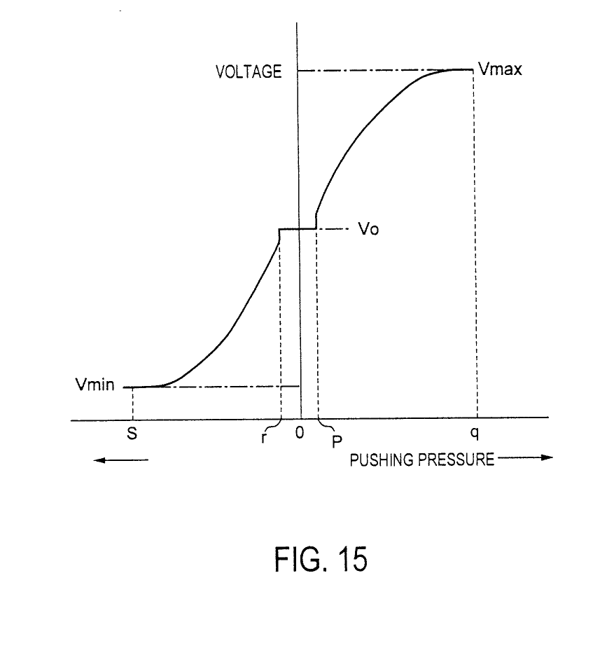

FIG. 15 is a graph showing the characters of the analog signal (voltage) output from the output terminal of the resistor,

First, since a voltage is applied to the resistor 40 when the power is turned on, even if the individual control keys 211a of the control unit 211 are not pressed, a fixed analog signal (voltage) V₀ is provided as output from the output terminal 40c (at position 0 in the graph).

Next, even if one of the individual control keys 211a is pressed, the resistance value of this resistor 40 does not change until the conducting member 50 contacts the resistor 40, and the output from the resistor 40 remains unchanged at V₀.

Furthermore, if the up-directional key or left-directional key is pushed until the conducting member 50 comes into contact with the first variable resistor 43 portion of the resistor 40 (at position p in the graph), thereafter the surface area of contact between the conducting member 50 and the first variable resistor 43 portion increases in response to the pushing pressure on the control key 211a (control elements), and thus the resistance of that portion is reduced so the analog signal (voltage) output from the output terminal 40c of the resistor 40 increases. Furthermore, the analog signal (voltage) output from the output terminal 40c of the resistor 40 reaches the maximum Vₘₐₓ when the conducting member 50 is most deformed (at position q in the graph).

On the other hand, if the down-directional key or right-directional key is pushed until the conducting member 50 comes into contact with the second variable resistor 44 portion of the resistor 40 (at position r in the graph), thereafter the surface area of contact between the conducting member 50 and the second variable resistor 44 portion increases in response to the pushing pressure on the control key 211a (control elements), and thus the resistance of that portion is reduced, and as a result, the analog signal (voltage) output from the output terminal 40c of the resistor 40 decreases.

Furthermore, the analog signal (voltage) output from the output terminal 40c of the resistor 40 reaches the minimum Vₘᵢₙ when the conducting member 50 is most deformed (at position s in the graph).

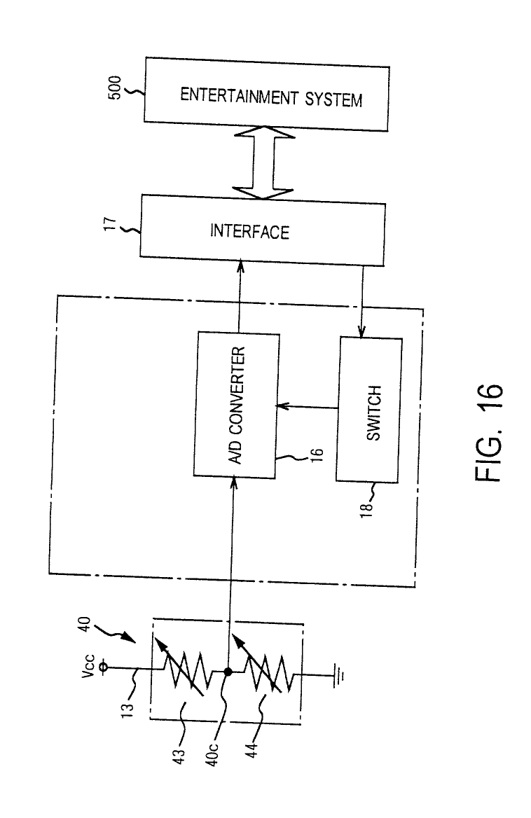

As shown in FIG. 16, the analog signal (voltage) output from the output terminal 40c of the resistor 40 is provided as input to an A/D converter 16 and converted to a digital signal. It is to be noted that the function of the A/D converter 16 shown in FIG. 16 is as described previously based on FIG. 11, so a detailed description shall be omitted here.

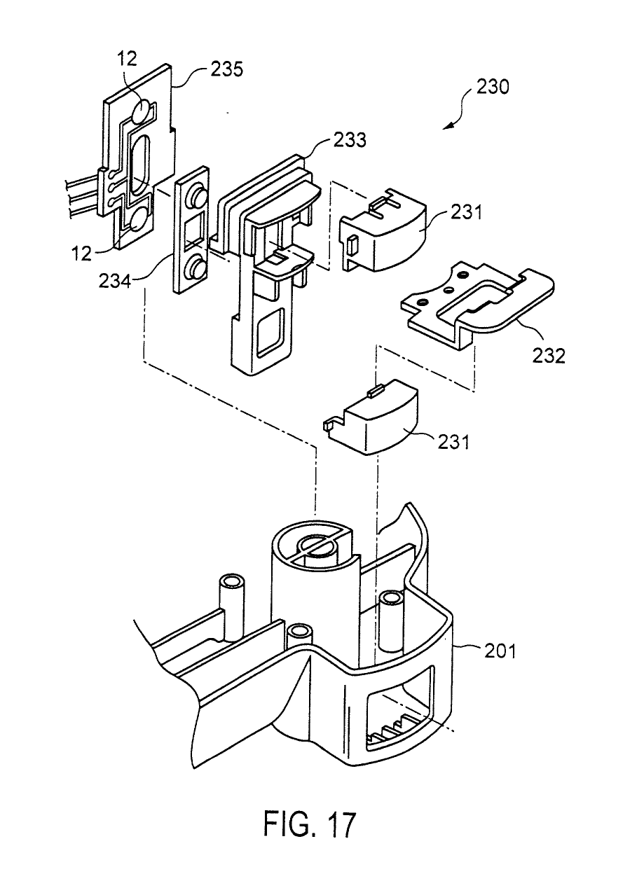

FIG. 17 is an exploded perspective view of the third control part of the controller.

The third control part 230 consists of two control buttons 231, a spacer 232 for positioning these control buttons 231 within the interior of the controller 200, a holder 233 that supports these control buttons 231, an elastic body 234 and an internal board 235, having a structure wherein resistors 40 are attached to appropriate locations upon the internal board 235 and conducting members 50 are attached to the rear surface of the elastic body 234.

The overall structure of the third control part 230 also already has been made public knowledge in the publication of unexamined Japanese patent application No. JP-A-H8-163672. The individual control buttons 231, however, can be pushed in while being guided by the spacer 232, the pushing pressure when buttons 231 are pressed, acts via the elastic body 234 on the pressure-sensitive device consisting of conducting member 50 and resistor 40. The electrical resistance value of the pressure-sensitive device varies depending on the magnitude of the pushing pressure it receives.

It is noted that the fourth control part 240 has the same structure as that of the third control part 230 described above.

In the above description, a flowchart for projectile shooting is shown in FIG. 4. This program can be provided either in a form recorded individually on a recording medium such as an optical disk, or in a form recorded on said recording medium together with game software as part of the game software. The projectile shooting program is activated on entertainment system 500 and executed on its CPU.

Here, the significance of the projectile shooting program being provided recorded individually on a recording medium is that it is made available previously as a library for software development. As is well known, in developing software it takes an enormous amount of time to write all the functions.

But if the software functions are broken up into single functions, then many functions will be included that are used in common by various software, such as the function of causing objects to move.

Thus functions that can be used in common such as this embodiment can be provided to software manufacturers as library programs. By having others provide such common functions as programs, software manufacturers can concentrate on just producing the essential part of their software other than its common-function parts.

In the foregoing, an embodiment of the present invention has been described. However, alternative embodiments can also be provided for this invention, In the embodiment, the pressure sensing value pressed by the user is used as is. However, in order to compensate for differences in users' physical strength or nervous reactions, the maximum value of a user's pressure sensing value can be corrected to the maximum game pressure sensing value set by the program, with intermediate values corrected proportionately. Such compensation is done by preparing a compensation table. Also, a user's pressure sensing value can be corrected by a well known function and used as the game pressure sensing value. In addition, the maximum value of a user's pressure sensing value rate of change can be corrected to a program-set maximum game pressure sensing value rate of change, with intermediate values corrected proportionately. For these specific techniques, see the present inventors' Japanese patent application H2000-40257 and the corresponding PCT/JP/(Applicant's file reference No. SC00097WO00).

With this invention, a method for using a controller is provided in which the game's value is enhanced without eliminating the rapid-fire function.

This invention can improve the user interface, making it even easier to use than the conventional rapid firing with an on-off switch, and enhancing the game's value over using a dedicated rapid-fire switch.

1. A recording medium on which are recorded shooting game software programs, including programs that process as commands an output from a controller that has a pressure sensing means, that can be read and executed by a computer, to which the controller is connectable, wherein
said software programs include processing programs that shoot projectiles in a screen of the computer in a number that corresponds to said output of said controller.

2. The recording medium as described in claim 1, wherein a number of said projectiles to be shot per unit time is varied according to a rate of change per unit time of an output value of said controller.

3. The recording medium as described in claim 1, wherein the number of said projectiles to be shot per unit time is varied according to the size of the output value of said controller.

4. A method for executing shooting games on a computer by using a pressure-sensitive controller, comprising the steps of:
detecting a pressure by a user in a shooting operation, by a pressure sensing means provided on the controller,
determining a number of projectiles to be shot in accordance with said pressure in the shooting operation, detected by said pressure sensing means;
shooting a determined number of projectiles to be shot by a user character on a monitor at the computer; and
deciding whether an enemy character has been hit.

5. The method as described in claim 4, wherein in the step in which the number of projectiles to be shot is determined in accordance with the pressure in the shooting operation detected by said pressure sensing means, the number of projectiles to be shot is determined in accordance with a rate of change per unit time of the pressure in the shooting operation.

6. The method described in claim 4, wherein in the step in which the number of projectiles to be shot is determined in accordance with the pressure in the shooting operation detected by said pressure sensing means, the number of projectiles to be shot is determined in accordance with an amount of the pressure in the shooting operation.

7. The method described in claim 4, wherein in the step in which the number of projectiles to be shot is determined in accordance with the pressure in the shooting operation detected by said pressure sensing means,
the number of projectiles to be shot is determined in accordance with a rate of change of the amount of the pressure in the shooting operation in a previous time and the amount of the pressure in the shooting operation at the current time.

8. A computer that executes a shooting game in an entertainment system comprising:
a controller having a pressure sensing means that detects an operation pressure in a shooting operation by a player playing the shooting game
a means that determines a number of projectiles to be shot in accordance with the operation pressure in the shooting operation, detected by said pressure sensing means;
a means that shoots the determined number of projectiles to be shot by the player character on a monitor of the computer; and
a means that decides whether an enemy character has been shot.

9. The computer as described in claim 8, wherein the means that determines the number of projectiles to be shot in accordance with the pressure of the shooting operation detected by said pressure sensing means
decides the number of projectiles to be shot in accordance with a rate of change per unit time of said operation pressure of the shooting operation.

10. The computer as described in claim 8, wherein the means that determines the number of projectiles to be shot in accordance with the operation pressure in the shooting operation, detected by said pressure sensing means,
decides the number of projectiles to be shot in accordance with an amount of the operation pressure of the shooting operation.

11. The computer as described in claim 8, wherein the means that determines the number of projectiles to be shot in accordance with the pressure of the shooting operation detected by said pressure sensing means
decides the number of projectiles to be shot in accordance with a rate of change of the size of the operation pressure in the shooting operation at the previous time and an amount of the operation pressure at the current time.
